(19) United States
(12) Patent Application Publication
(10) Pub. No.: US 2009/0219012 A1
(43) Pub. Date: Sep. 3, 2009

(54) MICROELECTRONIC SENSOR DEVICE FOR CONCENTRATION MEASUREMENTS

(75) Inventors: Jeroen Hans Nieuwenhuis, Waalre (NL); Hans Van Zon, Waalre (NL); Josephus Arnoldus Henricus Maria Kahlman, Tilburg (NL); Jeroen Veen, Nijmegen (NL); Bart Michiel De Boer, Den Bosch (NL); Theodorus Petrus Henricus Gerardus Jansen, Deurne (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,698

(22) PCT Filed: Apr. 24, 2007
(86) PCT No.: PCT/IB07/51505

§ 371 Date: Nov. 5, 2008

(30) Foreign Application Priority Data
May 9, 2006 (EP) 06113707.1

(51) Int. Cl. G01N 27/74

(52) U.S. Cl. 324/204; 73/61.71

(57) ABSTRACT

The invention relates to a method and a magnetic sensor device for the determination of the concentration of target particles (2) in a sample fluid, wherein the amount of the target particles (2) in a sensitive region (14) is observed by sampling measurement signals with associated sensor units (10a-10d). The target particles (2) may optionally be bound to binding sites (3) in the sensitive region, and a parametric binding curve, e.g. a Langmuir isotherm, may be fitted to the sampled measurement signals to determine the desired particle concentration in the sample. Moreover, parameters like the sampling rate and the size of the sensitive region (14) can be dynamically fitted during the ongoing sampling process to improve the signal-to-noise ratio. In another embodiment of the invention, single events corresponding to the movement of target particles into, out of, or within the sensitive region are detected and counted.

The invention relates to a method and a microelectronic sensor device for the determination of the amount of target particles in a sample, wherein the amount of target particles in a sensitive region is measured. Moreover, it relates to a magnetic sensor device for detecting magnetized particles.

From the WO 2005/010543 A1 and WO 2005/010542 A2 (which are incorporated into the present application by reference) a microelectronic magnetic sensor device is known which may for example be used in a microfluidic biosensor for the detection of molecules, e.g. biological molecules, labeled with magnetic beads. The microsensor device is provided with an array of sensor units comprising wires for the generation of a magnetic field and Giant Magneto Resistances (GMR) for the detection of stray fields generated by magnetized beads. The signal of the GMRs is then indicative of the number of the beads near the sensor unit. A problem of these and similar biosensors is that the concentration of the target substance is typically very low and that the measurement signals are therefore severely corrupted by different sources of noise. Moreover, the measurement signals are very sensitive to variations in the parameters of the read-out electronics, for example the sensitivity of the sensor unit.

Based on this situation it was an object of the present invention to provide means for improving the accuracy, robustness and/or signal-to-noise ratio of microelectronic sensor devices of the kind described above, particularly of magnetic biosensors, wherein these means shall preferably work for different concentrations of target substance.

This objective is achieved by a microelectronic sensor device according to claim 1, a method according to claim 2, and a magnetic sensor device according to claim 20. Preferred embodiments are disclosed in the dependent claims.

A microelectronic sensor device according to the present invention is intended for the determination of the amount of target particles in a sample. The target particles may for instance be biological molecules like proteins or oligonucleotides, which are typically coupled to a label like a magnetic bead or a fluorescent molecule that can readily be detected. The “amount” of the target particles may be expressed by their concentration in the sample, and the sample is typically a fluid, i.e. a liquid or a gas. The microelectronic sensor device comprises the following components:
a) A sample chamber for providing the sample. The sample chamber is typically an empty cavity or a cavity filled with some substance like a gel that may absorb a sample; it may be an open cavity, a closed cavity, or a cavity connected to other cavities by fluid connection channels.
b) A sensitive (one-, two-, or three-dimensional) region that lies adjacent to or within the sample chamber. The sensitive region may for example be a part of the walls of the sample chamber. In exceptional cases, the sensitive region may comprise the whole sample chamber.
c) At least one sensor unit for repetitively sampling measurement signals that are related to the amount of target particles in the sensitive region. The sensor unit may for example be adapted to measure optical, magnetic and/or electrical properties related to the target particles. The sampling may be done with some given sampling rate at discrete points in time, or the measurement signals may be obtained (quasi-) continuously.
d) An evaluation unit for determining the amount of target particles in the sample from the measurement signals that were sampled by the sensor unit. The evaluation unit may be realized by dedicated hardware on the same substrate as the sensor unit and/or by an external data processing device (microcomputer, microcontroller, etc.) that is equipped with appropriate software.

The invention further relates to a method for the determination of the amount of target particles in a sample provided in a sample chamber, wherein the method comprises the following steps:
a) Contacting the sample with a sensitive region.
b) Sampling with at least one sensor unit repetitively measurement signals that are indicative of the amount of target particles in the sensitive region.
c) Determining with an evaluation unit the amount of target particles in the sample from the sampled measurement signals.

The microelectronic sensor device and the method described above have the advantage that their determination of the amount of target particles in the sample is based on a plurality of measurement signals that were consecutively sampled during some observation period. The determination can thus exploit a redundancy to achieve a higher accuracy than the single measurements that are usual in the state of the art. Moreover, an estimation of the measurement error can be provided by a statistical analysis of the sampled measurements.

In the following, preferred embodiments that apply to both the microelectronic sensor device and the method defined above will be described.

In a first preferred embodiment of the invention, the sensitive region comprises specific binding sites for the target particles. The sensitive region may for example be a part of the walls of the sample chamber that is coated with hybridization probes which can specifically bind to complementary biological target molecules. Thus target particles of interest can selectively be enriched in the sensitive region, making the measurement specific to the target particles and increasing the amplitude of the measurement signals.

In a further development of the aforementioned approach, the measurement signals that are provided by the at least one sensor unit are indicative of the amount of target particles bound to the binding sites. This can for example be achieved by making the sensitive region small enough such that it substantially comprises only a volume in which target particles can only be if they are attached to a binding site. Alternatively, the amount of free (unbound) target particles within the sensitive region—which also contribute to the measurement signals—may be estimated and subtracted from the whole measurement signal to determine the amount of bound target particles. Finally, it is possible to remove unbound target particles from the sensitive region by some washing step (e.g. a fluid exchange or a magnetic repulsion of free target particles) to make the measurement signals only depend on the bound target particles.

In another variant of the aforementioned embodiment, a parametric binding curve is fitted to the sampled measurement signals, wherein preferably at least one of the fitted parameters is directly indicative of the amount of target particles in the sample. The binding curve can for example be provided by theoretical models of the binding process or simply be taken from general purpose functions for curve fitting (e.g. polynomials, sine curves, wavelets, splines, etc.). As the amount of target particles in the sample obviously has a critical influence on the binding kinetics, the binding curve will particularly reflect this value that is to be determined.

A particularly important realization of the aforementioned approach comprises the application of a Langmuir isotherm as a binding curve, which describes a large variety of different binding processes.

The fitting of the parametric binding curve, i.e. the adjustment of its parameters, can in general be achieved by any method known for this purpose from mathematics. Preferably, the fitting is achieved by a linear or a weighted least squares regression. In a weighted least squares regression, the weights may for example be determined by the expected or theoretical noise level which normally goes with the square-root of the number of particles.

A central aspect of the approach described above is that the amount of target particles in the sample is determined from a series of measurement signals, wherein the redundancy of these measurements is used to improve the accuracy of the final result and to provide an error estimation. According to a further development of the invention, the series of measurement signals is further exploited to adjust dynamically (i.e. during the ongoing sampling process) the configuration and parameter settings of the measurement device for improving the signal-to-noise ratio of the final results. One particularly important example of a parameter that can dynamically be adjusted is the sampling rate, i.e. the frequency with which measurement signals indicative of the amount of bound target particles are generated by the sensor unit. A further parameter of particular importance is the size of the sensitive region. As this size has opposite effects on different kinds of noise, there exists an optimal value for which the generated noise is minimal.

In a preferred embodiment of the invention, the sampling rate is adjusted such that it is of the same order as or larger than the binding rate of target particles to binding sites in the sensitive region (i.e. larger than about 5% of the binding rate). Said binding rate describes the net number of target particles that are bound to the sensitive region per unit of time. Making the sampling rate as large as the binding rate or a larger guarantees that in the mean each binding event will be captured by the measurement signals, thus providing complete information about the binding process.

In the aforementioned embodiment, the sampling rate can be adjusted once at the beginning of the sampling process. The determination results can however be improved if the binding rate is estimated during the sampling process from the momentarily available measurement signals and if the sampling rate is dynamically adjusted according to these estimations of the binding rate. Thus it is possible to start a sampling process without any previous knowledge about the sample and the amount of target substance therein and to improve in one or more steps the sampling rate as one crucial parameter of the process based on the most recently available information.

The size of the sensitive region may optionally be adjusted based on a given value of the sampling rate, wherein said adjustment is typically done such that the theoretically or empirically determined signal-to-noise ratio is optimized. The given value of the sampling rate may for example be determined before the sampling process starts or dynamically during the ongoing sampling process according to the principles described above. The size of the sensitive region may then accordingly be adjusted once at the beginning of the sampling process or dynamically during this process based on the most recent values of the sampling rate.

A preferred way to adjust the size of the sensitive region is by functionally coupling various numbers of sensor units to one “super-unit”.

As was already mentioned, the sensor unit may particularly be adapted to measure magnetic fields. In a preferred embodiment of this variant, the sensor unit comprises at least one magnetic sensor element for measuring magnetic fields, wherein said sensor element may particularly comprise a coil, a Hall sensor, a planar Hall sensor, a flux gate sensor, a SQUID (Superconducting Quantum Interference Device), a magnetic resonance sensor, a magneto-restrictive sensor, or a magneto-resistive element like a GMR (Giant Magneto Resistance), a TMR (Tunnel Magneto Resistance), or an AMR (Anisotropic Magneto Resistance) element.

The sensor unit may further comprise at least one magnetic field generator for generating a magnetic excitation field in the sensitive region. Thus magnetic entities (e.g. target particles comprising magnetic beads) may be magnetized in order to detect their presence by excited reaction fields.

In a further development of the microelectronic sensor device and/or the method of the present invention, the measurement signals that are provided by the sensor unit are indicative of “events” that are by definition related to the movement of (at least) a limited number of target particles into the sensitive region, out of the sensitive region and/or within the sensitive region. Preferably, the limited number is “one”, i.e. the measurement signals can resolve events related to the movement of single target particles. The detection of events caused by single or a few target particles provides insights into the microscopic behavior of the system under investigation that can favorably be exploited to determine the amount of target particles in the sample. Particular embodiments of this approach will be described in more detail in the following.

Thus the evaluation unit may for example be adapted to detect and count the events indicated by the measurement signals. Detection of an event in a (quasi-) continuous measurement signal may for example be achieved via matched filters that are sensitive to the specific signal shapes of the events. Counting the detected events, which can readily be realized by e.g. a digital microprocessor, will then provide data that are directly related to the amount of target particles in the sensitive region. If the counted events correspond for example to the entrance of single target particles into or their escape from the sensitive region, the total number of target particles inside the sensitive region can be determined by observing the process from the beginning on, starting with a sensitive region free of target particles. The great advantage of this counting approach is that the detection of events is very robust with respect to variations in e.g. the sensor electronics, because an event can reliably be recognized even if its particular shape varies in a broad range. This is comparable to the high robustness of digital data encoding and processing with respect to analog procedures.

The evaluation unit may preferably be adapted to determine the changing rate and/or the amplitude step in the measurement signals that are associated with an event. The amplitude step obviously comprises information about the number of target particles that enter or leave the sensitive region. The changing rate with which such an amplitude step takes place may provide valuable information, too, because it is related to the movement velocity of the target particles. The determination of the changing rate may thus for example allow to determine the average velocity of the target particles in the sample.

According to another embodiment, the evaluation unit may be adapted to discriminate between events that correspond to the movement of single target particles and the movement of clustered target particles, respectively. The clustering of target particles, particularly particles labeled with magnetic beads, is often an undesired but unavoidable process taking place in a sample. The clustered target particles usually deteriorate the measurement results. A cluster of e.g. four target particles that is bound to one binding site may for example wrongly be interpreted as four single target particles occupying four binding sites. The accuracy of the measurement results may therefore be improved if the effects caused by clusters can be discriminated from the effects of single particles. Such a discrimination between single and clustered target particles may in the described embodiment for example be achieved based on differences in their movement velocity, which is typically larger for the clusters.

The evaluation unit may further be adapted to determine the amount of unbound target particles in the sensitive region from events corresponding to target particles entering and/or leaving the sensitive region. The target particles that are free to move, i.e. not fixed to binding sites in the sensitive region, will usually follow a random walk due to their thermal motion. The rate with which such target particles cross the interface between the sensitive region and the residual sample chamber depends on the amounts of target particles on both sides of said interface (or, more specifically, their concentrations). Detecting events of interface crossings will thus allow to estimate said amounts.

The invention further comprises a magnetic sensor device with an electrically driven magnetic sensor component for detecting magnetized particles in an associated (one-, two-, or three-dimensional) sensitive region, wherein the size of said sensitive region can dynamically be adjusted. In this context, “dynamical adjustment” is to be understood as a change of the sensitive region that can be made (and reversed) at arbitrary times by external commands or inputs; the term shall particularly distinguish the adjustments meant here from changes of the design at the time of the production of the magnetic sensor device or from physical reconstructions of the device, which are of course always possible. Moreover, it should be noted that the magnetic sensor component by definition needs the electrical energy it is driven with to provide measurement signals indicative of the detected magnetized particles.

The dynamical adjustment of the sensitive region allows to tune a parameter that has turned out to have a crucial influence on the detection of magnetized particles. The positive effects of this approach will be described in more detail in the following with respect to specific embodiments of the magnetic sensor device.

In general, there are many possibilities to change the size of the sensitive region in a magnetic sensor device of the kind described above. In a preferred realization, the magnetic sensor component comprises a plurality of magnetic sensor elements that can selectively be coupled in parallel and/or in series. By coupling different numbers and/or configurations of individual magnetic sensor elements to one “super-unit”, the resulting sensitive region, which is composed of the individual sensitive regions of all coupled magnetic sensor elements, can stepwise be adapted as desired. A change of the sensitive region can thus be achieved by a reconfiguration of the network of coupled magnetic sensor elements, for instance by closing/opening appropriate switches.

According to a further development of the aforementioned embodiment, the magnetic sensor elements can selectively be coupled in such a way that a predetermined distribution of coupled magnetic sensor elements is achieved in a given investigation region, wherein said distribution is preferably homogenous. Thus a whole investigation region can be covered with effectively different sizes of sensitive regions.

In a further development of the invention, the magnetic sensor device comprises an electrically driven magnetic field generator for generating a magnetic (excitation) field in an associated excitation region, wherein the size of said excitation region can dynamically be adjusted. The magnetic field generator uses the supplied electrical energy to generate the magnetic excitation field, which is preferably used to magnetize particles which shall thereafter be detected by the magnetic sensor component.

While there are again many possibilities to realize the dynamically adjustable excitation region, it is preferred that the magnetic field generator comprises a plurality of individual magnetic excitation elements that can selectively be coupled in parallel and/or in series. Furthermore, these magnetic excitation elements can preferably be coupled such that a predetermined (preferably homogenous) distribution of coupled magnetic excitation elements is achieved in a given investigation region.

In general, the sensitive region associated to the magnetic sensor component and the excitation region associated to the magnetic field generator may be separate. Preferably, these regions will however partially or completely overlap.

The adjustment of the sensitive region or the excitation region may be exploited for different purposes. Preferably, the size of the sensitive region and/or the size of the excitation region is adjusted such that the signal-to-noise ratio of the magnetic sensor device is optimized, as analysis shows that this ratio is significantly influenced by the size of said regions.

Moreover, the size of the sensitive region and/or the size of the excitation region may be adjusted such that a predetermined ratio between thermal (i.e. temperature dependent) noise and statistical noise (i.e. noise caused by the magnetized particles) is achieved in the overall signal of the magnetic sensor component, wherein said ratio optionally may vary between 80% and 120% of its nominal value. As will be described in more detail with reference to the Figures, the ratio of the noises typically has a crucial influence on the signal-to-noise ratio.

The magnetic sensor component may particularly comprise a coil, a Hall sensor, a planar Hall sensor, a flux gate sensor, a SQUID (Superconducting Quantum Interference Device), a magnetic resonance sensor, a magneto-restrictive sensor, or a magneto-resistive element like a GMR (Giant Magneto Resistance), a TMR (Tunnel Magneto Resistance), or an AMR (Anisotropic Magneto Resistance) element.

In a particular embodiment of the invention, the magnetic sensor device comprises an alternating sequence of resistances functioning as magnetic excitation element and magnetic sensor component, respectively. It may for example consist of a sequence “wire-GMR-wire-GMR- . . . ”, wherein the wires are individually addressable magnetic field generators and the GMRs are individually addressable sensors.

These and other aspects of the invention will be apparent from and elucidated with reference to the embodiment(s) described hereinafter. These embodiments will be described by way of example with the help of the accompanying drawings in which:

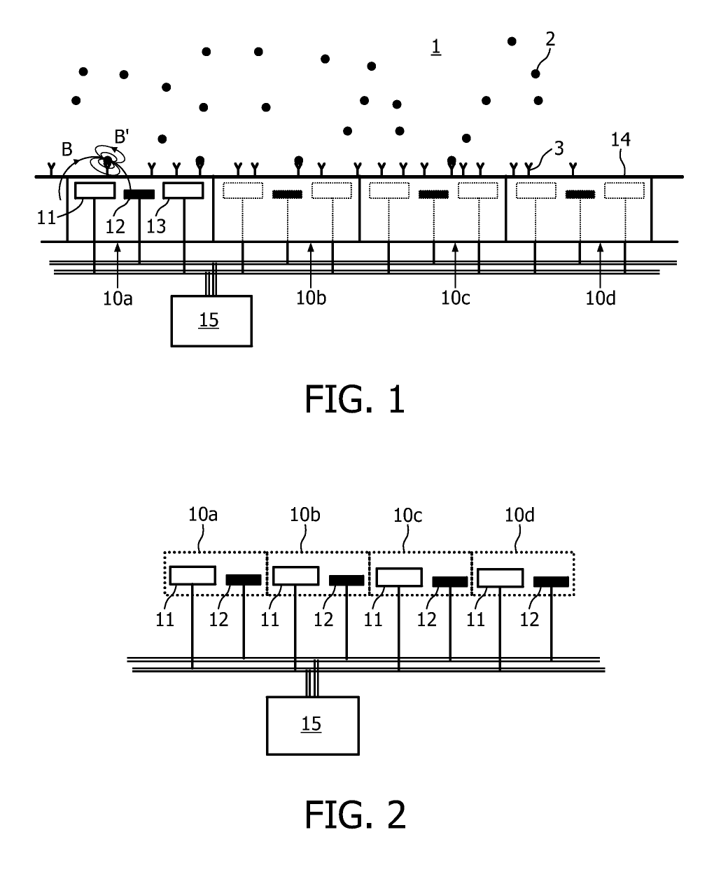

FIG. 1 shows schematically a section through a magnetic sensor device according to the present invention, wherein two excitation wires are associated to each sensor element;

FIG. 2 shows a variant of the magnetic sensor device of FIG. 1, wherein each excitation wire is shared between neighboring sensor elements;

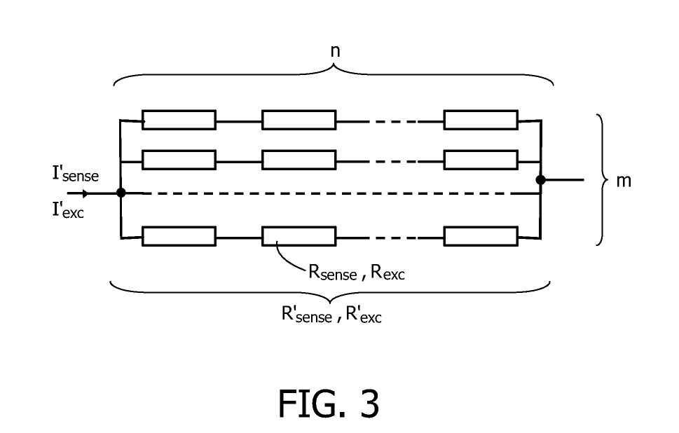

FIG. 3 shows magnetic sensor elements or magnetic excitation elements coupled in series and in parallel;

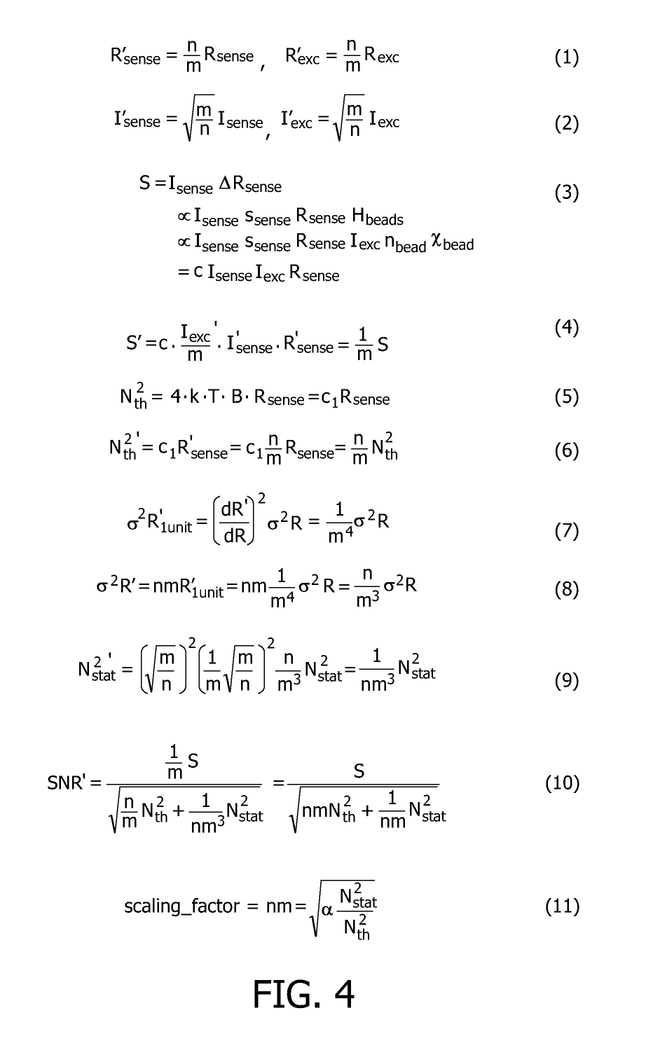

FIG. 4 summarizes formulae of an analysis of the relation between the signal-to-noise ratio and the sensor area;

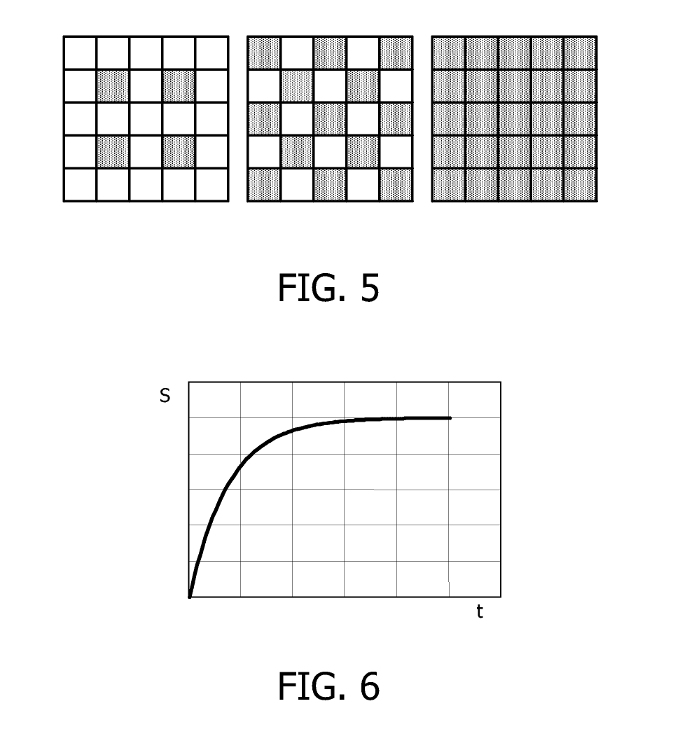

FIG. 5 shows schematically how a given investigation region can be covered by distributed sensitive regions of different size;

FIG. 6 shows a Langmuir isotherm;

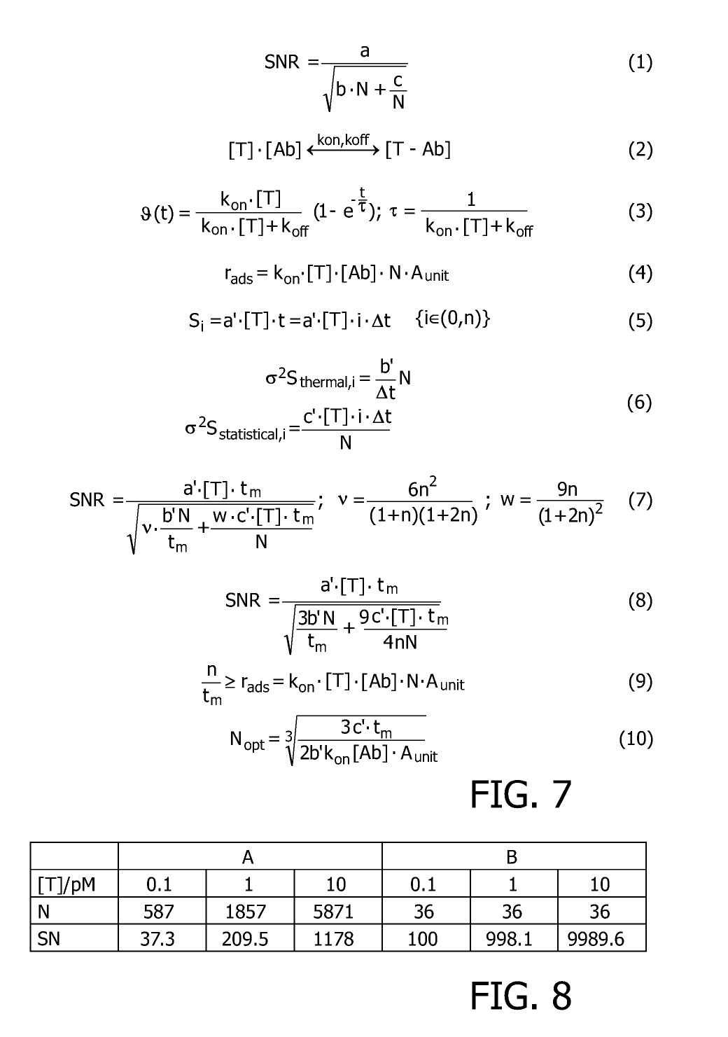

FIG. 7 summarizes different formulae relating to the dynamic measurement approach of the present invention;

FIG. 8 shows a comparison of characteristic data for measurements according to the state of the art (A) and to the present invention (B);

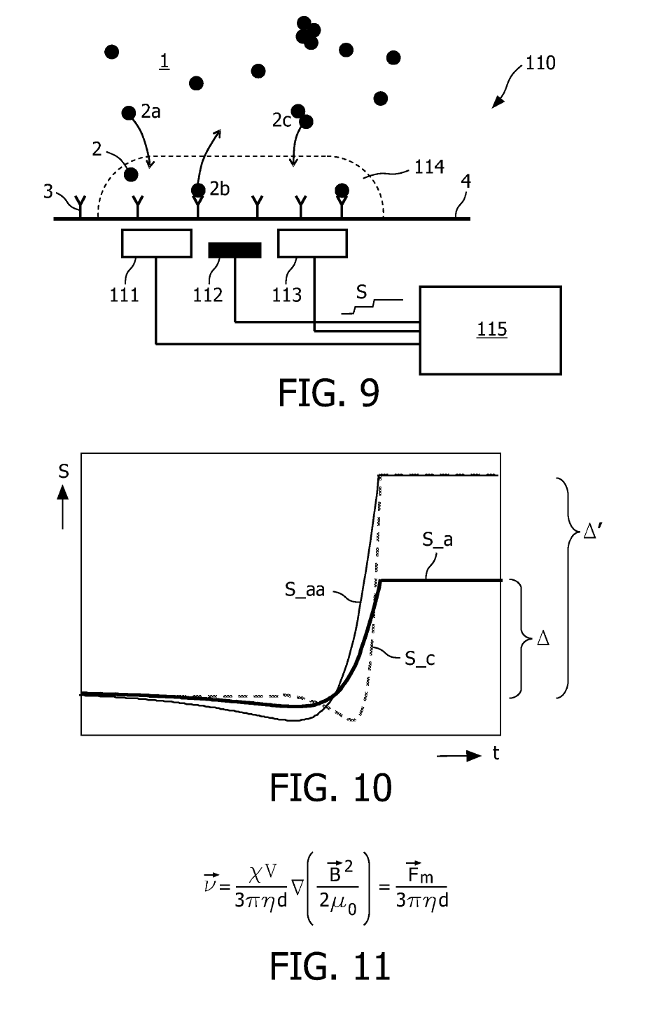

FIG. 9 shows schematically a section through a magnetic sensor device according to another embodiment of the present invention, in which single events related to the movement of target particles are detected;

FIG. 10 shows schematically signal shapes corresponding to different events of target particle movement;

FIG. 11 shows a formula for the (average) velocity of a particle moving in a viscous fluid under the influence of a (e.g. magnetic) force Fₘ.

Like reference numbers or numbers differing by integer multiples of 100 refer in the Figures to identical or similar components.

FIG. 1 illustrates a microelectronic biosensor according to the present invention which consists of an array of (e.g. 100) sensor units 10a, 10b, 10c, 10d, etc. The biosensor may for example be used to measure the concentration of target particles 2 (e.g. protein, DNA, amino acids, drugs) in a sample solution (e.g. blood or saliva). In one possible example of a binding scheme, this is achieved by providing a sensitive surface 14 with first antibodies 3 to which the target particles 2 may bind. For simplicity it is assumed here that the target particles which have to be analyzed are already labeled (i.e. attached to a magnetic particle or bead) such that they can be traced. Whether this is actually the case depends on the used biochemical assay. An excitation current flowing in the wires 11 and 13 of a sensor unit 10a will generate a magnetic field B which magnetizes the magnetic beads of the target particles 2. The stray field B′ from these magnetic beads introduces an in-plane magnetization component in the Giant Magneto Resistance (GMR) 12 of the sensor unit 10a, which results in a measurable resistance change.

FIG. 1 further shows an evaluation and control unit 15 that is coupled to the excitation wires 11, 13 for providing them with appropriate excitation currents and to the GMR elements 12 for providing them with appropriate sensor currents and for sampling their measurement signals (i.e. the voltage drop across the GMR elements 12). As indicated, a plurality of identically designed sensor units 10a, 10b, 10c, and 10d is coupled in this way to the evaluation and control unit 15. These sensor units therefore cooperate as one single “super-unit” that can determine the amount of target particles 2 bound in the sensitive region 14 which is defined by the area above these sensor units 10a-10d. By functionally coupling various numbers of sensor units to one “super-unit”, the effective size of said sensitive region 14 can thus be adjusted as desired.

FIG. 2 shows in a simplified drawing a practically important variant of the sensor device of FIG. 1, in which excitation wires 11 and GMR elements 12 are arranged in an alternating sequence. Each magnetic field generator consists in this embodiment of only one excitation wire 11 instead of two such wires 11, 13 as in FIG. 1. The effect of each excitation wire 11 is therefore shared between neighboring GMR elements 12, and the shown subdivision into sensor units 10a, 10b, 10c, 10d etc. is made arbitrarily.

The concentration of the target particles 2 which has to be measured can be very low, depending on the biochemical application. To reach a detection limit which is as low as possible, the sensor geometry, electronics and detection algorithms have to be optimized. Furthermore, preferably the device should be able to detect different kinds of target particles which requires multiple sensors onto a single die.

In the following it will first be shown that the signal-to-noise ratio (SNR) of a magnetic biosensor can be optimized by optimizing the size of its sensitive region, i.e. the “sensor area”, as different noise sources scale differently with sensor area. In the presented analysis, the SNR will be the performance indicator for which the optimization is carried out, and constant power dissipation will be assumed during the optimization process, because typically the total power dissipation is limited by temperature and battery lifetime considerations. Moreover, the scaling of the sensor area is discussed by describing the effect of combining multiple sensor units (e.g. the sensor units 10a to 10d of FIG. 1 or 2).

FIG. 3 shows a general connection scheme of a “super-unit” comprising the connection of n GMR resistors with individual resistance Rₛₑₙₛₑ in series and the connection of m of these series in parallel. The same connection scheme shall be realized in the “super-unit” for the associated magnetic field generators. It should be noted in this respect that each magnetic field generator may consist of several individual excitation wires (e.g. two wires 11, 13 in the case of FIG. 1, one wire 11 in the case of FIG. 2), and that the symbol R_{exc} shall denote the total resistance of each magnetic field generator (corresponding for example to the parallel resistance of the two individual wires 11, 13 in the case of FIG. 1). The following considerations are based on the embodiment of FIG. 1 and apply the corresponding definition of R_{exc}.

To determine how the SNR scales with sensor area, the scaling effects on the sensor signal and the main noise sources will be discussed first.

The complete circuit of FIG. 3 is fed with a total current I′ₛₑₙₛₑ or, in case of excitation wires, with a total current I′_{exc}. For the series/parallel-connected network the total resistance R′ₛₑₙₛₑ of the whole super-unit sensor and the total resistance R′_{exc} of the whole super-unit magnetic field generator are given by equation (1) of FIG. 4. To maintain equal power dissipation, the total sensing current I′ₛₑₙₛₑ and the total excitation current I′_{exc} through the series/parallel-connected network should scale as in equation (2), where Iₛₑₙₛₑ and I_{exc} are the sensing and excitation currents, respectively, through an individual resistance Rₛₑₙₛₑ, R_{exc} that has the same power dissipation.

The sensor signal S provided by an individual sensor element can be expressed as in equation (3), where Iₛₑₙₛₑ is the current through the sensor element, sₛₑₙₛₑ is the sensitivity of the sensor element (dR/dH)_{H-0}/R, Rₛₑₙₛₑ is the resistance of the sensor element, I_{exc} is the current through the associated excitation element, n_{bead} is the number of beads on the associated area of the sensor element, and X_{bead} is the magnetic susceptibility of a single bead.

In the same way the signal change S′ of the series/parallel-connected network can be expressed by equation (4). The factor 1/m expresses the reduction in the excitation current due to the distribution of the current over the series/parallel network. By substituting equations (1) and (2), the signal S′ can be expressed in terms of the signal S.

The thermal noise power, Nₜₕ², of an individual sensor element can be expressed as in equation (5), where k is the Boltzmann constant, T is absolute temperature, and B is the bandwidth. The thermal noise power scales directly with the total resistance of the magnetic sensor component; for a network consisting of series and parallel connected units the thermal noise power can therefore be expressed as in equation (6).

There are a few other noise sources that also lead to variations in the sensor signal:
1. The response of the sensor to beads is a function of the position of the beads on the sensor surface.
2. The beads vary in susceptibility, which means that different beads can give different signals.
3. The (Poisson) distributed arrival rate of the beads.

Since these noise sources scale equally with sensor area, they will be treated here all at once. The statistical noise power of a single sensor element, Nₛₜₐₜ², translates to a statistical noise contribution of the series/parallel-connected network as expressed in equation (7). The uncorrelated variation of all n times m sensor units in the total network therefore works out as in equation (8).

These statistical noise sources scale with the sensor signal per network element, therefore the noise contribution needs to be multiplied by the scaling of the currents Iₛₑₙₛₑ and I_{exc} per element, cf. equation (9).

The overall signal-to-noise ratio SNR′ can then be expressed as in equation (10). From this expression two very important conclusions can be drawn:
The SNR with respect to thermal noise scales with (nm)^{1/2}, and the SNR with respect to the statistical noise sources scales with (nm)^{-1/2}. So by scaling the sensor area, the balance between the contribution of both noise source can be shifted.
The total noise consists of the combined contribution of the thermal noise sources and the statistical noise sources. When expression (10) is maximized for nm, an optimum is found where the total contribution of the thermal noise sources and the statistical noise sources are in a fixed ratio α. For the configuration of FIG. 1, α is equal to one. For other configurations, e.g. when there is a common excitation wire between neighboring magnetic sensor elements (FIG. 2), α will have a value deviating from 1. The value for nm is the scaling factor that results in the optimal sensor area. The optimal scaling factor for the sensor area can be expressed by equation (11).

Expression (10) shows that for the SNR it does not matter whether multiple elements are connected in series or in parallel. The choice between series and parallel can thus be made in accordance with the read-out electronics.

The statistical noise is a function of the sensor signal and therefore its value changes with the bead concentration on the surface of the sensor. The thermal noise is constant in time. Therefore, the optimal sensor area is a function of the concentration of bound target: For large concentrations the signal is much larger than the thermal noise. By increasing the area (increasing n×m), the signal is reduced in favor of a better statistics.

In summary, it has been derived that the optimal sensor area can be optimized for the bead concentration on the sensor surface. However, there are situations where this bead concentration is not always the same. Thus different target concentrations will lead to different concentrations of bound beads at the sensor surface. For each concentration there is an optimal sensor area. To get optimal performance one should use a differently sized sensor for each target concentration. This is not very practical. What makes it even harder is that typically the target concentration is not known beforehand.

As will be derived below, it is advantageous to continuously measure the sensor signal during the binding process of the beads. This means that the concentration of beads on the sensor surface continuously increases over time. To maintain the optimal SNR during the experiment, the sensor area needs to scale with time.

To perform optimal measurements with a magnetic biosensor under these circumstances a sensor is required of which the (active) sensor area can be adapted dynamically. This can be realized by splitting up the entire sensor area into multiple blocks. Depending on the concentration of beads on the surface, one or multiple sensor blocks can be read-out. When the target concentration on the sensor surface increases over time, the optimal SNR can be maintained by distributing the total power over ever more sensor blocks. FIG. 5 shows this situation for a quadratic investigation region or sensor area that is composed of 5×5 tiles corresponding to individual sensor elements. By addressing the sensor elements individually, the active sensor area (dark tiles) can be adapted. From left to right of FIG. 5 ever more sensor elements are switched on to measure increasingly higher concentrations. To keep the temperature distribution as uniform as possible over the sensor area it is advantageous to distribute the active sensor blocks as evenly as possible over the sensor area.

Based on the above observations, a signal analysis method will be described in the following which increases the signal-to-noise ratio of the sensor device such that lower concentrations of target particles can be detected, decreases the required area of the sensor device, allowing more sensors onto one die, thus allowing a larger variety of substances which can be measured simultaneously, and makes the sensor design independent of the concentration of target particles.

In the sensor units 10a, 10b, . . . of a magnetic sensor device like that of FIG. 1, thermal noise from the sensor resistor 12 and from the electronics, and statistical noise caused by various factors such as bead position and variation in bead diameter influence the accuracy of the signal. By increasing the sensitive area of the biosensor (which e.g. can be done by placing N sensor units 10a-10d in a series and/or parallel connection), the statistical variation in the signal can be reduced. Since the power which is dissipated in the complete sensor is fixed due to temperature restrictions, increasing the area will lead to a reduction of the currents through the excitation wires 11, 13 and the sensor elements 12, causing a decrease of the signal with respect to the thermal noise. Therefore, an optimum in area of the sensitive region 14 or in the number N of sensor units exists. As was proven above, the signal-to-noise ratio SNR for the described scenario has the general form of equation (1) depicted in FIG. 7, wherein a, b, and c are constants with b·N being the variance corresponding to the thermal noise and c/N being the variance corresponding to the statistical noise. By maximizing the SN-ratio with respect to N, the optimum value N=✓(c/b) is obtained. In this case the thermal noise term has become equal to the statistical noise term. As will be shown below, the general form of the signal-to-noise ratio can favorably be altered by means of a dynamic signal analysis.

In order to detect one particular kind of target particle—in the following without loss of generality assumed to be a protein 2—, the surface of the sensor device is prepared with species (anti-bodies) such that only one particular kind of protein can attach, i.e. the binding or adsorption sites 3 are specific for the protein 2 of interest. In an unused sensor device, no magnetic beads will be detected by the sensor units since no proteins are yet present. Once the sample solution to be analyzed is brought into the sample chamber 1 and comes into contact with the sensor surface, the proteins 2 with magnetic label start reacting with the prepared sensitive region 14. With increasing time, more proteins 2 will be bound to the surface 14 and the sensor signal will increase in time. The rate at which the signal increases in time is dependent on the concentration of the proteins 2 in the sample solution which is the actual parameter which needs to be determined. After a certain time an equilibrium state is reached in which the rate at which the proteins 2 are bound to the sensitive region 14 is equal to the rate at which the proteins are released again. This time-dependent adsorption mechanism is called “Langmuir adsorption”, and FIG. 6 shows an example of a corresponding binding curve. On the horizontal axis the time t is shown, and on the vertical axis the sensor signal S which is linearly dependent on the number of proteins bound to the sensitive region 14.

To describe the time-dependent occupation of the sensor surface, several parameters are of importance such as the concentration of the proteins 2 in the solution (target concentration [T], measured e.g. in mol per unit volume), the number of possible adsorption sites 3 on the surface (antibody concentration [Ab], measured e.g. in sites per unit area), a parameter which describes the chance of attachment of a protein 2 to an antibody 3 (the “forward” reaction constant kₒₙ), and a parameter which describes the release of the protein 2 from the antibody 3 (the “reverse” reaction constant k_{off}). Formula (2) of FIG. 7 represents the corresponding reaction equation. Given these parameters, the time-dependent surface coverage is generally described by a Langmuir isotherm according to equation (3), wherein θ(t) is the fraction of the surface covered at time t with proteins (or better, the fraction of antibodies which have reacted with a protein) and τ is the time constant of the system. For typical values of the concentrations and the reaction constants (kₒₙ=10⁵ M⁻¹s⁻¹, k_{off}=10⁻⁵ s⁻¹, [T]=1 pM), the time constant τ is much larger than the typical measurement time tₘ (e.g. 1 minute) and thus the surface coverage increases linearly with time for t<tₘ. The net number of proteins 2 adsorbing to the surface per unit time then equals the adsorption rate r_{ads} (or “binding rate”) of equation (4), in which Aᵤₙᵢₜ is the area of one sensor unit and N is the number of functionally coupled sensor units 10a-10d.

In an end-point measurement which is typically used by a number of known techniques, one would inject the sample solution into the sample chamber 1, wait for some time tₘ and do a readout of the sensor signal. From the signal, the number of proteins 2 on the surface can be determined and thus the concentration in the solution. However, from the signal no estimation of the error in the signal can be obtained other than the theoretically expected error. In the following it will be shown that the described magnetic biosensor device allows a dynamic measurement of the slope of the binding curve which a) will allow a more accurate determination of the slope than a single end-point measurement, and b) will give an estimation of the error in the slope as well.

The slope of the Langmuir isotherm at t=0 is linearly dependent on the target concentration [T]. By determining this slope, the concentration can therefore be calculated. If the Langmuir isotherm consists of a discrete number of n measured points, the slope can be determined by using a linear (or a weighted linear) regression. Assuming a total measurement time tₘ, each individual measurement lasts a sampling time Δt=tₘ/n and the sampling rate at which the signal is sampled is equal to 1/Δt. The sensor signal is linearly dependent on the number of bound proteins, so the signal Sᵢ from an individual measurement i in time can be written as in equation (5) with a proportionality constant a′.

The slope of the signal versus i·Δt is equal to a′·[T]. As previously described, the noise in the signal consists of two different kinds of noise: a) the thermal noise in the sensor units and electronics, which is independent of the number of particles and averages out better for longer sampling times Δt, and b) statistical noise. The latter noise signal scales with ✓[T]. The variances in the individual data points are described by equation (6).

By using linear regression on the n data points, it can be shown that the signal-to-noise ratio, SNR, of the slope a′·[T] can be written as in equation (7). For a relatively large number of data points (i.e. n→∞), this SNR reduces to equation (8).

Given a maximum allowed measurement time tₘ, the SNR of the biosensor has to be optimized with respect to the number of data points n (and thus the sampling rate) and the number of sensor units N. However, since the target concentration [T] is still present in the expression (8), the sensor can only be optimized for one specific concentration, which is disadvantageous.

To overcome this limitation, it is proposed to adapt the number n of data points (and thus the sampling rate) to the concentration [T]. More specific, the sampling rate, n/tₘ, is chosen equal or faster than the adsorption rate of the proteins according to equation (9). In words this means that the sampling rate should be fast enough to catch all adsorption events since every adsorption event carries information. Taking a sampling rate (orders of magnitude) slower than the adsorption rate misses information, sampling faster does not add extra information but also does not harm the SN-ratio. By substituting n from equation (9) in equation (8), the optimal value Nₒₚₜ for which the signal-to-noise ratio is maximal with respect to N becomes independent of the target concentration [T], cf. equation (10).

Since the adsorption rate r_{ads} is unknown at the beginning of the measurement, it is further proposed to split the measurement into two or more parts:
a) During a first measurement of duration t₁, the adsorption rate r_{ads} is measured with a sensor configuration containing N₁ sensor units such that the complete sensor is reasonably optimized for measuring the adsorption rate in a relatively short time duration.
b) During a second measurement of duration tₘ-t₁, the sample rate is adapted to the expected adsorption rate r_{ads} (cf. equation (9)) and the sensor configuration is changed according to equation (10) to N₂ sensor units to optimize its SN-ratio.
c) In the same way, the second measurement can also be split into more parts, if desired, in order to get a better estimation of the adsorption rate r_{ads} and a better SN-ratio.
d) In the limit of a large number of splits, the sampling rate and the sensor configuration (number of sensor units) is continuously adapted to the adsorption rate r_{ads}.

The advantage of using a regression technique with optimized sampling rate over an end-point method where only one data point is taken at t=tₘ is four-fold:
a) One sensor design can be used for all target concentrations.
b) The number of sensor units in a complete sensor device can become much smaller, allowing multiple sensors within one die.
c) The SN-ratio is much higher.
d) An estimation about the error is given by the measurement.

The table of FIG. 8 gives an impression of the gain in SNR and sensor size (represented by N) which can be obtained by the proposed dynamic analysis technique (right columns B) in comparison to the state of the art (left columns A).

In summary, the central aspects of the proposed method are:
1. Determining the concentration of target particles via a linear or weighted least squares regression of the slope of the Langmuir isotherm between t=0 and t=tₘ instead of an end-point measurement.
2. Adjusting the sampling rate to at least the adsorption rate r_{ads} of the target.
3. Adjusting the sensor size by increasing or decreasing the number N of sensor units to optimize the signal-to-noise ratio.
4. Measuring the adsorption rate r_{ads} by a first sensor configuration/settings and continue measuring with a more optimized configuration/settings to maximize the SN-ratio for the particular concentration to be measured.
5. Continuously adapting the sampling rate to the adsorption rate.

Instead of performing an end-point measurement with the biosensor in which first the target molecules of interest are collected on the sensor surface, followed by the actual measurement of the target concentration, it is proposed here to dynamically measure the collection process with the advantage that the concentration measurement can be done much more accurately while also an estimation of the statistical error can be obtained.

In the following, further embodiments of the present invention will be described that are based on the detection of events related to the movement of single target particles (or at least a small number of target particles). FIG. 9 shows in this respect schematically one sensor unit 110 of a magnetic sensor device that comprises a sample chamber 1 with a bottom surface 4 coated with binding sites 3, wherein magnetic excitation wires 111, 113 and a GMR sensor 112 are embedded in a substrate below the bottom surface 4 of the sample chamber. The excitation wires and the GMR sensor are coupled to an evaluation unit 115 which reads out the measurement signals S provided by the GMR sensor and evaluates them. As the design of this sensor unit 110 corresponds to the sensor elements 10a-10d of FIG. 1, further details may be found in the description of that Figure.

It should be noted that the sensor device may optionally comprise any combination of the features described with respect to the previous Figures (and vice versa). Moreover, it should be noted that the detection principle which will be described in the following with respect to the magnetic sensor unit 110 are also applicable to other types of sensors, for example optical sensors that use the principle of frustrated total internal reflection of an incident light beam at the bottom surface 4.

FIG. 9 indicates with dotted lines the interface of the “sensitive region” 114, which is by definition the sub-volume of the sample chamber 1 in which target particles 2 cause a (measurable) reaction in the GMR sensor 112. The target particles 2 in the sample chamber 1 are continuously in motion due to their thermal energy. With respect to this movement and the sensitive region 114, different events can be distinguished:
The entrance of a target particle 2a into the sensitive region 114 (wherein said particle 2a may then be bound to a binding site 3 or not).
The escape of a target particle 2b from the sensitive region 114 (wherein said target particle 2b may have been bound before to a binding site 3 or not).
The entrance of a cluster 2c comprising N>1 (in the shown case N=2) target particles into the sensitive region 114.
The escape of such a cluster from the sensitive region 114.

Conventionally, biosensors are operated in the linear regime, i.e. the sensor response is proportional to the density of target particles 2 (e.g. super-paramagnetic beads linked to target molecules in the sensitive region). In order to relate the sensor response to the exact concentration of target particles in the sample volume, the sensor sensitivity has to be calibrated. During measurements the sensor sensitivity or the properties of the read-out apparatus may slightly change and an additional control system is required to check and correct these variations.

To address these problems, a non-linear read-out method for microelectronic sensor devices is proposed that is based on the movement of target particles explained above. This method distinguishes from conventional linear read-out by detecting signal events, i.e. short time occurrences or persistent signal changes resulting from movements of target particles in the sensitive region.

By detecting and counting events in the sensor signal that correspond to the entrance of target particles into the sensitive region, particularly to their binding, the number of immobilized target particles on the sensor surface can be determined without (re-) calibration. The method further enables discrimination of signal events corresponding to single target particle binding or to the binding of clustered particles, thereby making the detection method robust to clustering.

Due to the fact that target particles move into and out of the sensitive region by thermal motion, the number of free target particles above the sensor can be determined by detecting and counting events in the sensor signal that correspond to target particles entering and leaving the sensitivity volume.

In the following, a number of signal realizations corresponding to particular events in the sensitive region is analyzed, but the proposed method is not limited to these particular events or analysis. In addition, the proposed signal analysis techniques can be operated in place of or complementary to linear detection methods.

By detecting and counting events in the sensor signal S that correspond to label binding, the number of immobilized target particle labels on the sensor surface can be determined. To that end, the rate at which the sensor response is sampled must be sufficiently high so that individual binding events can be distinguished.

Curve “S_a” of FIG. 10 shows an exemplary event in a magnetic biosensor signal S resulting from a target particle 2a (FIG. 9) that enters the sensitive region 114 and binds to the sensor surface 4. The binding event gives rise to a small step Δ in the sensor output signal S. Since the target particle 2a does not leave the sensitive region 114 after binding, the signal change is persistent. If many target particles are bound to the sensor surface, the total signal equals the accumulated steps and the final signal amplitude relates to the target particle density (the linear detection method). By monitoring the number of binding events, the target particle density can also be determined.

The exact amplitudes Δ of the binding event signals are of secondary importance, thus making this non-linear method independent of the sensor sensitivity, its calibration or variations therein, as well as non-uniformity of the particle labels.

Curve “S_aa” of FIG. 10 shows the signal that results if two single target particles 2a happen to bind to the sensor surface 4 at exactly the same time-instant. The amplitude Δ′ of the corresponding signal event is twice as large as the response in case of a single event (curve S_a). Also with a non-calibrated sensor, these composite and single events can thus easily be discriminated based on the difference in amplitude.

In practice, the sensor signal S will be perturbed with noise. Based on prior knowledge of the signal shapes corresponding to binding events, filters can be constructed to match these signals (cf. e.g. L. A. Wainstein and V. D. Zubakov, Extraction of signals from noise, Prentice-Hall, Englewood Cliffs, UK, 1962). Matched filters can be applied in a signal post-processing system for the purpose of increasing the signal-to-noise ratio and thus the ability to detect binding events. The present invention encloses the application of matched filters to binding event detection, but is not limited to this technique. Other methods for the detection of binding events in the sensor signal are also included.

As was already explained, the target particles 2 may attach to each other forming more or less large clusters 2c. A sensor signal that corresponds to the entrance of such a cluster 2c (with N=2 particles) into the sensitive region 114 and its binding to the sensor surface 4 is shown in curve “S_c” of FIG. 10. It has a large and steep step that can clearly be distinguished from single binding events (curve S_a) or composite binding events (curve S_aa) based on the signal rise time, i.e. the changing rate dS/dt. After detection of cluster-related events, the sensor output may be corrected for said clusters.

A more detailed analysis of the aforementioned situation starts with the observation that the target particle velocity determines the rise time of the signal step, being defined as the time the signal requires to increase from its initial value to its persistent value. In the sensitive region 114, the target particle velocity v is dominantly governed by the magnetic force exerted by the excitation wires 111, 113. As can be seen from the formula of FIG. 11, the velocity v increases quadratic with the target particle diameter d, where X is the target particle susceptibility, V=π/6d³ equals the target particle volume, and 3πηd equals the coefficient of friction exerted by the fluid with viscosity η. The magnetic field at the target particle position is denoted by B.

Loosely speaking, a cluster of N target particles can be regarded as a single target particle having an N times larger volume, or equivalently having a N^{1/3} larger diameter. The velocity of said cluster thus scales with N^{2/3}, and consequently the rise time of the signal increases with this factor, as illustrated by curve S_c of FIG. 10.

The sensor response is proportional to the magnetic moment of a bead, and thus to the target particle susceptibility and volume. As a result the persistent signal from a cluster bound to the sensor surface is substantially larger than that of a single bead. In a first approximation, the amplitude of the signal step that is induced by a cluster of N particles is N-times larger than the step induced by a single particle.

By simultaneous analysis of the rise time and amplitude of the step signal, cluster binding events can be discriminated from single target particle binding events. Moreover, consideration of the rise time helps to discriminate the binding of N-particle clusters from occasionally occurring simultaneous bindings of N single particles, as is illustrated by curves S_aa and S_c in FIG. 10 for N=2.

Based on prior knowledge of the signal shapes corresponding to cluster binding events, filters can be constructed to match these signals. The present invention encloses the application of matched filter banks to both single binding event detection and cluster detection, but is not limited to this technique.

According to another aspect of the described approach, the number of free target particles 2 above the sensor can be determined by detecting and counting pulses in the sensor signal S that correspond to target particles 2 entering and leaving the sensitive region 114. Due to thermal motion, target particles 2 constantly move into and out of the sensitive region 114. The number of particles in the sensitive region is characterized as a spatial Poisson process, with mean and variance equal to the average number of particles in the volume. The sensor response to a target particle 2 migrating into and out of the sensitive region 114 will result in a signal pulse. Clearly, such a pulse does not have a persistent value, since the target particle will leave the sensor sensitivity zone, and can thus be distinguished from binding events. By counting the number of pulse events during the diffusion time, an estimate of the number of target particles in the volume can be obtained.

The average number of free target particles 2 in the sensitive region 114 is linearly related to the total number of target particles in the sample volume. In particular if an inhibition assay is used to detect small molecules, the knowledge of the number of target particles in the sample volume is essential.

It was already discussed that the rise time of a signal event is proportional to the target particle velocity. By examining the rise time distributions of the various signal classes enclosed in the previously described embodiments, the average velocity of target particles 2 can be determined. If the average properties of the target particles (or their labels) such as susceptibility and volume are known, then the average magnetic force acting on the target particles can be determined. From this information and the average velocity measurements, the fluid viscosity η may be obtained according to the formula of FIG. 11.

The main advantages of the embodiments shown in FIGS. 9 to 11 are:
no sensor sensitivity calibration is required;
robustness to sensor/read-out electronics variations;
robustness to non-uniformity of the super-paramagnetic particle labels, i.e. susceptibility and volume;
robustness to clustered particle labels;
continuous observation;
no additional hardware required.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic sensor device for the determination of the amount of target particles (2) in a sample, comprising
a) a sample chamber (1) for providing the sample;
b) a sensitive region (14, 114) that is disposed adjacent to or within the sample chamber (1);
c) at least one sensor unit (10a-10d, 110) for sampling repetitively measurement signals that are related to the amount of target particles (2) in the sensitive region (14, 114);
d) an evaluation unit (15, 115) for determining the amount of target particles (2) in the sample from the repetitively sampled measurement signals.

2. A method for the determination of the amount of target particles (2) in a sample provided in a sample chamber (1), comprising
a) contacting the sample with a sensitive region (14, 114);
b) sampling with at least one sensor unit (10a-10d, 110) repetitively measurement signals that are related to the amount of target particles (2) in the sensitive region (14, 114);
c) determining with an evaluation unit (15, 115) the amount of target particles (2) in the sample from the repetitively sampled measurement signals indicative of the amount of target particles (2) bound to the binding sites (3).

3. The microelectronic sensor device according to claim 1,
characterized in that the sensitive region (14, 114) comprises specific binding sites (3) for the target particles (2).

4-31. (canceled)

32. The microelectronic sensor device according to claim 1.
characterized in that a parametric binding curve is fitted to the sampled measurement signals, wherein preferably one of the fitted parameters is indicative of the amount of target particles (2) in the sample.

33. The microelectronic sensor device or the method according to claim 3,
characterized in that the sampling rate is adjusted to be of the same order as or larger than the binding rate of target particles (2) to binding sites (3) in the sensitive region (14, 114).

34. The microelectronic sensor device according to claim 1,
characterized in that the size of the sensitive region (14, 114) is adjusted based on a given value of the sampling rate or alternatively the size of the sensitive region (14, 114) is adjusted by coupling various numbers of sensor units (10a-10d, 110).

35. The microelectronic sensor device according to claim 1,
characterized in that the sensor unit (10a-10d, 110) comprises at least one magnetic sensor element for measuring magnetic fields, particularly a magnetic sensor element that comprises a coil, a Hall sensor, a planar Hall sensor, a flux gate sensor, a SQUID, a magnetic resonance sensor, a magneto-restrictive sensor, or a magneto-resistive element like a GMR (12, 112), an AMR, or a TMR element.

36. The microelectronic sensor device according to claim 1,
characterized in that the measurement signals (S) are indicative of events related to the movement of a limited number of target particles (2)—preferably of single target particles (2, 2a, 2b)—into, out of and/or within the sensitive region (114), whereby the evaluation unit (15, 115) is adapted to detect and count said events indicated by the measurement signals (S) and/or to determine the changing rate and/or the amplitude step of the measurement signals (S) that are associated with an event, to discriminate between events corresponding to the movement of single target particles (2a, 2b) and of clustered target particles (2c), respectively, and/or to determine the amount of unbound target particles (2) in the sensitive region (114) from events corresponding to target particles entering into and/or escaping from the sensitive region (114).

37. A magnetic sensor device, comprising an electrically driven magnetic sensor component for detecting magnetized particles (2) in an associated sensitive region (14, 114), wherein the size of said sensitive region (14, 114) can dynamically be adjusted.

38. The magnetic sensor device according to claim 37,
characterized in that the magnetic sensor component comprises a plurality of magnetic sensor elements (12, 112) that can selectively be coupled in parallel and/or in series such that a predetermined distribution of coupled magnetic sensor elements (12, 112) is achieved in a given investigation region.

39. The magnetic sensor device according to claim 37,
characterized in that it comprises an electrically driven magnetic field generator for generating a magnetic field (B) in an associated excitation region (14, 114), wherein the size of said excitation region (14, 114) can dynamically be adjusted.

40. The magnetic sensor device according to claim 39,
characterized in that the magnetic field generator comprises a plurality of magnetic excitation elements (11, 13, 111, 113) that can selectively be coupled in parallel and/or in series such that a predetermined distribution of coupled magnetic excitation elements (11, 13, 111, 113) is achieved in a given investigation region.

41. The magnetic sensor device according to claim 37,
characterized in that the size of the sensitive region (14, 114) and/or of the excitation region (14, 114) is adjusted such that the signal-to-noise ratio of the magnetic sensor device is optimized and alternatively such that a predetermined ratio between thermal noise and statistical noise, which is caused by the magnetized particles (2) and can vary between 80% and 120% of its nominal value, is achieved in the overall signal of the magnetic sensor component.

42. The magnetic sensor device according to claim 37,
characterized in that the magnetic sensor component comprises a coil, a Hall sensor, a planar Hall sensor, a flux gate sensor, a SQUID, a magnetic resonance sensor, a magneto-restrictive sensor, or a magneto-resistive element like a GMR (12, 112), an AMR, or a TMR element.

43. The magnetic sensor device according to claim 39,
characterized in that it comprises an alternating sequence of resistances functioning as magnetic excitation element (11) and magnetic sensor component (12), respectively.

44. The method according to claim 2, characterized in that the sensitive region (14, 114) comprises specific binding sites (3) for the target particles (2).

45. The method according to claim 2,
characterized in that a parametric binding curve is fitted to the sampled measurement signals, wherein preferably one of the fitted parameters is indicative of the amount of target particles (2) in the sample.

46. The method according to claim 2,
characterized in that the size of the sensitive region (14, 114) is adjusted based on a given value of the sampling rate or alternatively the size of the sensitive region (14, 114) is adjusted by coupling various numbers of sensor units (10a-10d, 110).

47. The method according to claim 2,
characterized in that the sensor unit (10a-10d, 110) comprises at least one magnetic sensor element for measuring magnetic fields, particularly a magnetic sensor element that comprises a coil, a Hall sensor, a planar Hall sensor, a flux gate sensor, a SQUID, a magnetic resonance sensor, a magneto-restrictive sensor, or a magneto-resistive element like a GMR (12, 112), an AMR, or a TMR element.

48. The method according to claim 2,
characterized in that the measurement signals (S) are indicative of events related to the movement of a limited number of target particles (2)—preferably of single target particles (2, 2a, 2b)—into, out of and/or within the sensitive region (114), whereby the evaluation unit (15, 115) is adapted to detect and count said events indicated by the measurement signals (S) and/or to determine the changing rate and/or the amplitude step of the measurement signals (S) that are associated with an event, to discriminate between events corresponding to the movement of single target particles (2a, 2b) and of clustered target particles (2c), respectively, and/or to determine the amount of unbound target particles (2) in the sensitive region (114) from events corresponding to target particles entering into and/or escaping from the sensitive region (114).
